(19) United States
(12) Patent Application Publication
(10) Pub. No.: US 2005/0229406 A1
(43) Pub. Date: Oct. 20, 2005

(54) Composite tableware and method of manufacturing the same

(75) Inventor: Yin-Chu Lai, Changhua (TW)

Correspondence Address: DENNISON, SCHULTZ & DOUGHERTY, 612 CRYSTAL SQUARE 4, 1745 JEFFERSON DAVIS HIGHWAY, ARLINGTON, VA, 22202, US

(73) Assignee: LAYANA COMPANY

(21) Appl. No.: 10/825,233

(22) Filed: Apr. 16, 2004

(51) Int. Cl. B08B 3/00

(52) U.S. Cl. 30/324

(57) ABSTRACT

A piece of composite tableware and a method of manufacturing the same, the tableware comprises a main part of an utensil and a handle, the method is characterized by: the main part including a utility portion and a handle-connecting portion is integrally shaped, an opening is provided on an outer end of the handle-connecting portion, a fixing hole is provided at the opening; the handle is formed by injection shaping, extruding and melting, and is tightly connected to the interior of the handle-connecting portion through the opening to tightly connect with the main part. Integrally shaping the tableware makes cleansing the connecting areas become easier, and injection shaping to connect the main part and the handle increases the connecting strength. In addition, hollow barrel structure reduces the cost. The method is applicable to manufacturing of spoons, forks and bottle cap openers etc.

### BACKGROUND OF THE INVENTION

1. Field of the Invention

The present invention is related to composite tableware and a method of manufacturing the same, and especially to a method to integrally shape main parts of utensils and to form handles by injection shaping, extruding as well as melting, it suits for manufacturing of table spoons, forks, knives and bottle cap openers etc.

2. Description of the Prior Art

Tableware is daily necessity for modern people; it not only acts as basic tools for use in daily meals, but also gives good appearances to increase the mood in having meals. Sweet family gathering for dinners, successful commercial fellowship parties or joyful parties of friends often are endued with much attractiveness by using tableware of outstanding design. On the contrary, tableware from bad design or bad manufacturing may render displeasing in having meals, for example, it may have the result such as of dirt that is hard to clean or of breakage of forks being due to insufficient strength.

In order to manufacture a piece of beautiful and outstanding tableware, manufacturing smiths have paid efforts in hard study, some increase the functions of the tableware with special structures, some make outstanding appearances as their features, and some even emphasize colors and materials, however summarily, manufacturing of conventional tableware basically is divided into two kind of measures:

The first one uses only one kind of material of metal to integrally shape by founding and forging to make the main bodies of tableware, such as is shown in FIG. 4. Using only one kind of material renders the articles to have less variation. Because the virtue that metallic material has larger density, the article made there of is heaver, and thereby this often renders a user more cumbersome and inconvenient in use. And more, by the feature of the metallic material, in manufacturing, it should be processed by a specific way, normally it is manufactured by founding and forging; the cost for the entire process and equipment for manufacturing is extremely high, thereby the price of the product made of metallic material is overly high and is hard to be accepted by consumers.

The second one uses different kinds of materials to make the main bodies of tableware. Generally, for the convenience of cutting and taking foods in meal times, the parts of the tableware used, such as the knife parts, the recessed parts of spoons and the forked parts of forks, are all made of metal. In order to render tableware more abundant in variation, the handle parts of the tableware are mostly made of other materials such as wood, plastic or acryl.

The connecting structure and mode of a kind of conventional tableware is shown in FIG. 5, the connecting portion of the part used of the tableware is provided with a prolonged member A having a protrusion A1 and a recess A2, the connecting portion of a handle B of the tableware is provided with a hollow chamber B1 for insertion of the prolonged member A. When in connecting, the hollow chamber B1 is injected therein with adhesive or is heated to get tight closed, and then a force is exerted to forcedly insert the prolonged member A into the hollow chamber B1; the protrusion A1 of the prolonged member A then engages with the hollow chamber B1, while the adhesive in the recess A2 increases the connecting strength.

The connecting structure and mode of another kind of conventional tableware is shown in FIG. 6, the connecting portion of the part being used of the tableware is provided with a prolonged member C, the connecting portion of a handle E of the tableware is provided with a hollow chamber E1 adapted for heating insertion of the prolonged member C into the hollow chamber E1; the hollow chamber E1 is injected therein with adhesive and is coupled with a surrounding frame D, and then a force is exerted to forcedly insert the prolonged member C into the hollow chamber E1, the prolonged member C presses the adhesive in the hollow chamber E1 to fully fill the latter with the adhesive to tightly connect with the prolonged member C, to thereby increase the connecting strength of the tableware.

The connecting modes of parts of the both two kinds of tableware each has a utility portion with a prolonged member extending therefrom, a force is exerted to forcedly insert the prolonged member into the hollow chamber and a handle, and with adhesive filled in the hollow chamber of the prolonged member to get an object of tight connecting. However, this mode of connecting forcedly connects the two parts with an external force, and renders the connecting area of the two parts to be subjected to breaking by concentrated stress at this area, after using for a period of time, the utility portion and the handle are subjected to loosening; on the other hand, this connecting area is subjected to have dirt accumulated here, and it is hard to maintain neatness and beauty as well as sanitation in use.

In view of the above defects to be solved for providing a novel piece of composite tableware and a method of manufacturing the same, the inventor provides the present invention based on his professional experience of years in repeated experiments and improvement

### SUMMARY OF THE INVENTION

The primary object of the present invention is to provide a method of manufacturing composite tableware, it is suitable for combining various parts of different materials of each piece of composite tableware, thereby composite tableware with good appearance, durability and good connecting strength as well as reasonable cost of production can be obtained.

The components of the present invention include a main part of a utensil and a handle; the method of the present invention comprises the following steps: to make a main part of a utensil by integrally shaping to render one end of the main part to have a utility portion, to render a handle-connecting portion to be formed and extended to a direction away from the utility portion, to render an opening to be provided on an outer end of the handle-connecting portion, and to render a fixing hole to be provided near the opening; to form a handle by injection shaping, extruding as well as melting to make the handle be tightly connected to the interior of the handle-connecting portion through the opening as well as extended outwardly to complete the handle for holding by a hand and integrally connected with the main part of the utensil.

The present invention will be apparent after reading the detailed description of the preferred embodiment thereof in reference to the accompanying drawings.

### BRIEF DESCRIPTION OF THE DRAWINGS

FIG. 1 is a perspective view of an embodiment of the utensil of the present invention;

FIG. 1A is a side view showing an opening end of the handle-connecting portion of the present invention;

FIG. 2 is a perspective schematic view of the embodiment of the present invention;

FIG. 3 is a process chart showing the steps of manufacturing the present invention;

FIG. 4 is a perspective view of a piece of conventional tableware.

FIG. 5 is a perspective schematic view showing combination of another piece of conventional tableware;

FIG. 6 is a perspective schematic view showing combination of a further piece of conventional tableware.

### DETAILED DESCRIPTION OF THE PREFERRED EMBODIMENT

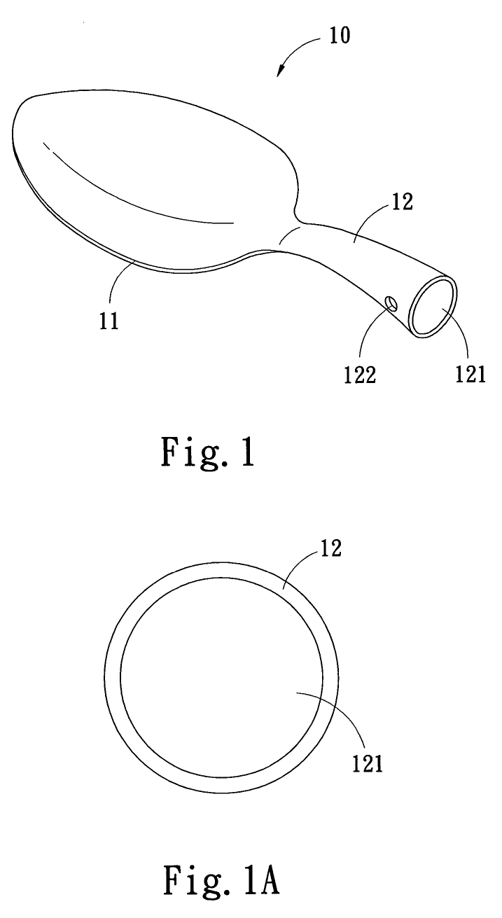

Referring firstly to FIGS. 1 and 1A depicting a perspective view of an embodiment of a main part of a utensil of the present invention, the main part 10 of the utensil is made by forging and integrally shaping into a metal piece, one end of the main part 10 has a utility portion 11, a handle-connecting portion 12 is extended to a direction away from the utility portion 11, an opening 121 is provided on an outer end of the handle-connecting portion 12, and a fixing hole 122 is provided near the opening 121; thus a handle 20 is formed by injection shaping, extruding or melting. In this embodiment, the handle-connecting portion 12 is in the form of a hollow barrel of the shape of a truncated cone of which an end with a larger area has the opening 121.

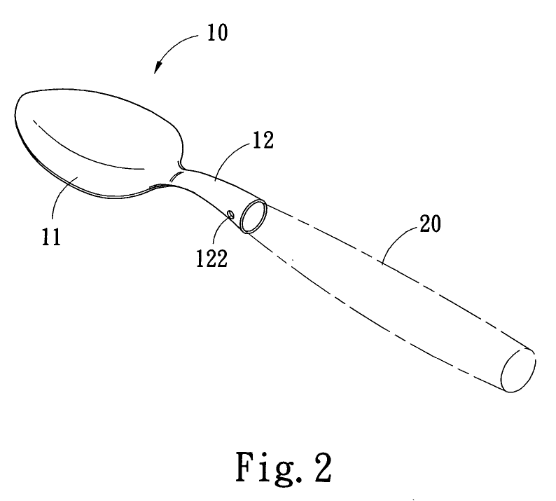

As shown in FIG. 2, after punch pressing the main part 10, the handle-connecting portion 12 is simultaneously shaped. FIG. 2 is a perspective view after assembling of the composite tableware of the present invention; wherein the opening 121 on the handle-connecting portion 12 of the main part 10 of the utensil accommodates a handle 20 integrally shaped and extending upwardly in the same extending direction as that of the handle-connecting portion 12. The handle 20 is made of plastic, acryl, ABS (acrylonitrile-butadiene-styrene copolymer), glass or ceramic, and is formed and connected in the interior of the handle-connecting portion 12; the end being injected of the handle 20 is extended into the handle-connecting portion 12 to increase the connecting strength of the main part 10 with the handle 20.

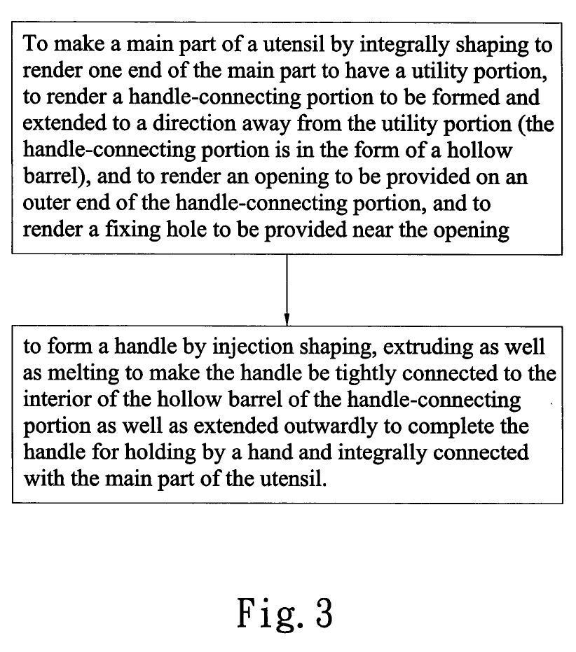

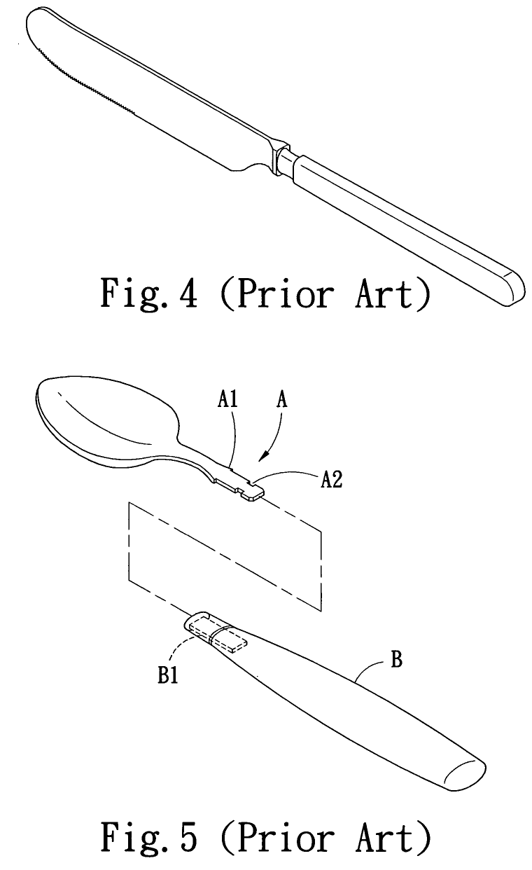

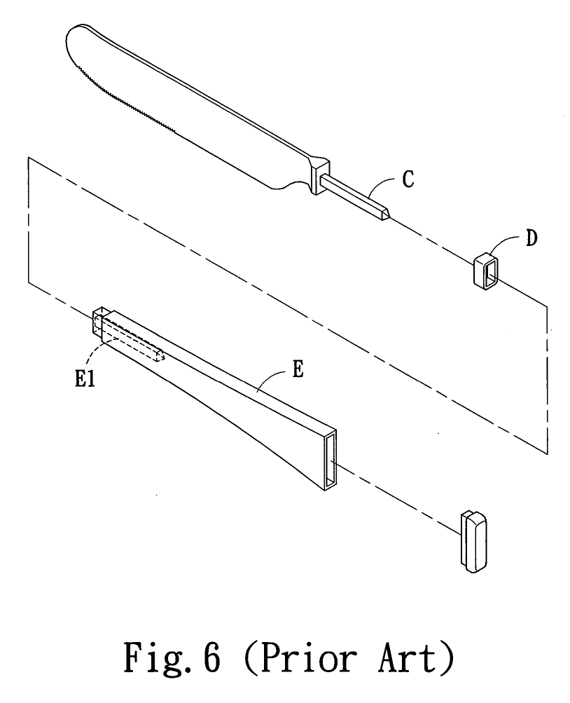

FIG. 3 is a process chart showing the steps of manufacturing the present invention, there are two steps: step 1 makes the main part 10 of the utensil by integrally shaping to render one end of the main part 10 to have the utility portion 11, to render the handle-connecting portion 12 to be formed and extended to a direction away from the utility portion 11, and to render the opening 121 to be provided on an outer end of the handle-connecting portion 12; and step 2 forms the handle 20 by injection shaping, extruding as well as melting to have the handle tightly connected to the interior of the handle-connecting portion 12 through the opening 121 as well as extended outwardly to complete the handle 20 for holding by a hand and integrally connected with the main part 10 of the utensil.

When in use, the main part 10 of utensil can be manufactured according to the purpose actually required, for example: the tong of a spoon, the shank with a blade of a knife, the fork portion of a fork, and the opening portion of a bottle cap opener. Not only such a main part 10 of the utensil integrally shaped has a good appearance, but also by integral connecting of the handle-connecting portion 12 with the handle 20, the dirt that is hard to clean at the connecting area of conventional tableware can be easily removed. Further, because the handle 20 is integrally connected in the handle-connecting portion 12, the connecting area is uneasy to be loosened. In addition, made of the main part 10 hollow metallic structure as well as the handle 20 manufactured of a different kind of material make the cost of production of the tableware of the present invention lower and further has higher acceptability in the market.

Therefore, the present invention has the following advantages:
1. The main part of the utensil of the present invention is a hollow metallic structure, which makes the cost of production lower for more reasonable price of the product, so the product can have higher acceptability in the market.
2. A part of the main part of the utensil of the present invention is a hollow metallic structure, which reduces the weight of the tableware to provide better convenience in use for children, elder, or any one who has difficulty in action.
3. The handle of the present invention is made of plastic, acryl, ABS, glass or ceramic, so the tableware can have various appearances, and by integral shaping of the main part, the entire appearance of the composite tableware is further more elegant and beautiful to increase the feeling of pleasure and comfort in using, and to increase the good feeling of having a meal for users.
4. The handle of the present invention is made to be connected in the handle-connecting portion, so that the handle is extended into the handle-connecting portion to be fixed by means of the fixing hole, and hence the strength of the connecting area of the main part with the handle can be increased, and the strength of the entire tableware is good and quite durable.
5. The handle of the present invention is made to be connected in the handle-connecting portion, so that the handle is extended into the handle-connecting portion to be fixed by means of the fixing hole, and hence the surface of the connecting area of the main part with the handle can be a smooth one, it is easy for cleansing, maintaining neatness, and can meet the requirement of sanitation.

In conclusion, according to the description disclosed above, the present invention surely can get the expected object thereof to provide a piece of improved composite tableware, and further to provided a method of manufacturing the same. The present invention is novel and inventive, having thus described my invention, what I claim as new and desire to be secured by Letters Patent of the United States are:

1. A piece of composite tableware comprising: a main part of an utensil and a handle, wherein:
said main part of said utensil is integrally shaped, one end thereof has a utility portion, a handle-connecting portion is extended to a direction away from said utility portion, an opening is provided on an outer end of said handle-connecting portion;
said handle is formed by injection shaping, extruding as well as melting, and is tightly connected to the interior of said handle-connecting portion through said opening as well as extends outwardly to complete said handle for holding by a hand and integrally connects with said main part of said utensil.

2. The composite tableware as in claim 1, wherein said handle-connecting portion at least has a fixing hole.

3. The composite tableware as in claim 1, wherein said handle-connecting portion is in the form of a hollow barrel.

4. The composite tableware as in claim 3, wherein said hollow barrel is a truncated cone of which an end near to said main part of said utensil has a smaller area, while the other end extending outwardly has a larger area.

5. The composite tableware as in claim 1, wherein said integrally shaped main part of said utensil is made of metal.

6. The composite tableware as in claim 5, wherein said integrally shaped main part of said utensil is formed by punch pressing.

7. The composite tableware as in claim 1, wherein said handle is made of plastic, acryl, glass, ceramic or ABS (acrylonitrile-butadiene-styrene copolymer).

8. The composite tableware as in claim 1, wherein said utility portion is a spoon, a fork or a bottle cap opener.

9. A method of manufacturing a piece of composite tableware, said method comprises the following steps:
integrally shaping a main part of a utensil to render one end of said main part to have a utility portion, to render a handle-connecting portion to be formed and extended to a direction away from said utility portion, and to render an opening to be provided on an outer end of said handle-connecting portion; and
injection shaping a handle, extruding as well as melting to have said handle tightly connected to the interior of said handle-connecting portion through said opening and extended outwardly to complete said handle for holding by a hand and integrally connected with said main part of said utensil.

10. The method of manufacturing a piece of composite tableware as in claim 9, wherein said handle-connecting portion at least has a fixing hole.

11. The method of manufacturing a piece of composite tableware as in claim 9, wherein said handle-connecting portion is the form of a hollow barrel.

12. The method of manufacturing a piece of composite tableware as in claim 11, wherein said hollow barrel is a truncated cone of which an end near to said main part of said utensil has a smaller area, while the other end extending outwardly has a larger area.

13. The method of manufacturing a piece of composite tableware as in claim 9, wherein said main part of said utensil is made of metal.

14. The method of manufacturing a piece of composite tableware as in claim 13, wherein said integrally shaped main part of said utensil is formed by punch pressing.

15. The method of manufacturing a piece of composite tableware as in claim 9, wherein said handle is made of plastic, acryl, glass, ABS or ceramic.

16. The method of manufacturing a piece of composite tableware as in claim 9, wherein said utility portion is a spoon, a fork or a bottle cap opener.
